(19) United States
(12) Patent Application Publication
(10) Pub. No.: US 2018/0109039 A1
(43) Pub. Date: Apr. 19, 2018

(54) METHOD FOR MANUFACTURING COMMUNICATION CONNECTOR AND COMMUNICATION CONNECTOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Hiroyoshi Maesoba, Yokkaichi, Mie (JP)

(21) Appl. No.: 15/567,233

(22) PCT Filed: Apr. 5, 2016
(86) PCT No.: PCT/JP2016/061056

§ 371 Date: Oct. 17, 2017

(30) Foreign Application Priority Data
Apr. 21, 2015 (JP) 2015-086922

(51) Int. Cl. H01R 13/6463; H01R 13/6592; H01R 43/042; H01R 43/28

(52) U.S. Cl. CPC H01R 13/6463; H01R 43/28; H01R 43/0421; H01R 13/6592

(57) ABSTRACT

A method for manufacturing a communication connector includes a cutting step of irradiating a laser beam to insulation layers 26 of a shield cable 17 with wires 11A, 11B each configured by coating a conductor part 16 with the insulation layer 26 and a conductive shield member 61 for surrounding the wires 11A, 11B, thereby cutting the insulation layers 26, a removing step of removing end parts 26A of the cut insulation layers 26 to expose end parts 16A of the conductor parts 16, and a connecting step of connecting the end parts 16A of the conductor parts 16 exposed in the removing step to terminals 20 accommodated in a housing 30.

### BACKGROUND

### Field of the Invention

The invention relates to a method for manufacturing a communication connector and a communication connector.

### Description of the Related Art

Japanese Unexamined Patent Publication No. 2008-507110 discloses a communication connector capable of receiving four USB plug connectors. This electrical connector includes a housing and electrical contacts bent into an L shape and made of metal.

Some of electrical connectors are configured such that an end part of each wire is connected to each electrical contact. Further, a shield layer and an insulation layer collectively surround the wires. The shield layer and the insulation coating need to be stripped at the end parts of the wires so that the electrical contacts can be connected to the wires. This causes parts not covered with the shield layer to be formed at the end parts of the wires and an impedance changes with respect to parts covered with the shield layer. It is concerned that signal reflection occurs to reduce communication quality at an impedance changing point.

The invention was completed based on the above situation and aims to suppress a situation where communication quality is reduced.

### SUMMARY

The invention is directed to a method for manufacturing a communication connector, the method includes a cutting step of irradiating a laser beam to an insulation layer of a shield cable with a wire configured by coating a conductor part with the insulation layer and a conductive shield member for surrounding the wire, thereby cutting the insulation layer. The method then includes a removing step of removing an end part of the cut insulation layer to expose an end part of the conductor part, and a connecting step of connecting the end part of the conductor part exposed in the removing step to a terminal accommodated in a housing.

In the present invention, the insulation layer is cut using a laser beam. In the case of cutting the insulation layer using a wire stripper or the like, the insulation layer needs to be held directly by the wire stripper and needs to be exposed by stripping the shield member. However, when the laser beam is used, as in the invention, a situation where the shield member is stripped to hold the insulation layer can be suppressed. Thus, a situation where a part not covered with the shield member is formed in the wire can be suppressed and a reduction of communication quality can be suppressed.

The shield cable may include two wires surrounded by the shield member, and the wires may form a twisted pair cable by being twisted with each other. The shield member surrounding the twisted pair cable need not be stripped. Thus, a situation where the twisted pair cable is untwisted can be suppressed.

The invention also is directed to a communication connector with wires for transmitting communication signals, terminals to be connected to the respective wires and a housing for accommodating the terminals. An insulation coating collectively covers the wires. An end part of each wire on the terminal side is exposed and not covered with the insulation coating. A conductive shield member surrounds at least one of the wires and is interposed between the insulation coating and the one wire and is configured to surround the exposed part of the one wire.

According to the invention, the end part of the wire on the terminal side is exposed and not covered with the insulation coating. This enables each wire to be bent easily bent at the end part and easily connected to each terminal. A part covered with the insulation coating and the exposed part are covered with the shield member. This can suppress a situation where an impedance changes between the part covered with the insulation coating and the exposed part in the one wire and can suppress a reduction of communication quality.

According to the present invention, it is possible to suppress a situation where communication quality is reduced.

### BRIEF DESCRIPTION OF THE DRAWINGS

FIG. 1 is a perspective view showing a communication connector according to one embodiment of the present invention.

FIG. 2 is a perspective view showing the communication connector in a state where a second shield case is removed.

FIG. 3 is a plan view showing the communication connector in the state where the second shield case is removed.

FIG. 4 is a perspective view showing the communication connector in a state where the second shield case and a shield cable are removed.

FIG. 5 is a front view showing the communication connector.

FIG. 6 is a plan view showing the communication connector in the state where the second shield case and the shield cable are removed.

FIG. 7 is a plan view showing a cutting step.

FIG. 8 is a plan view showing a removing step.

FIG. 9 is a section showing the communication connector.

### DETAILED DESCRIPTION

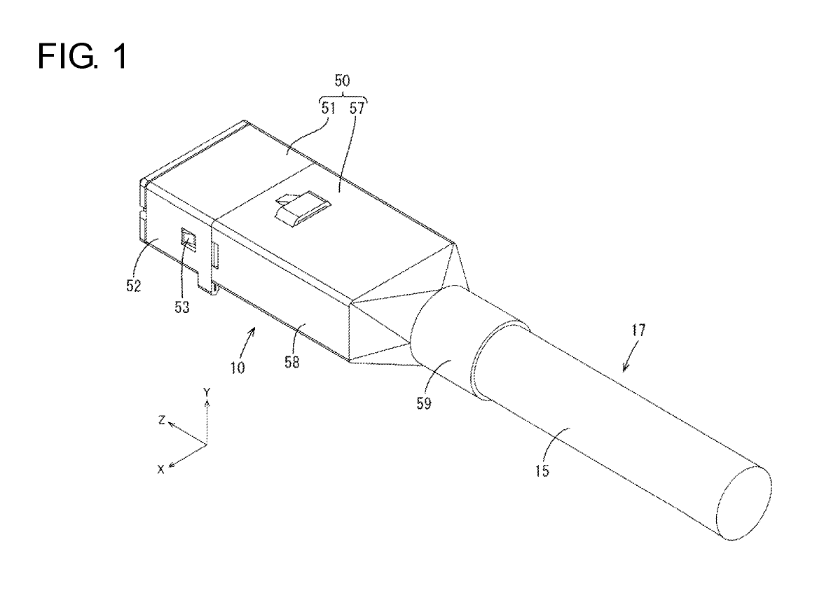

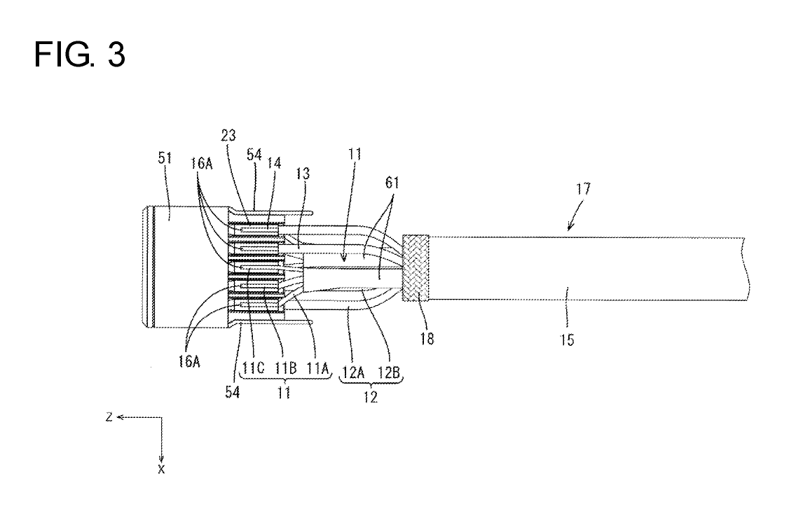

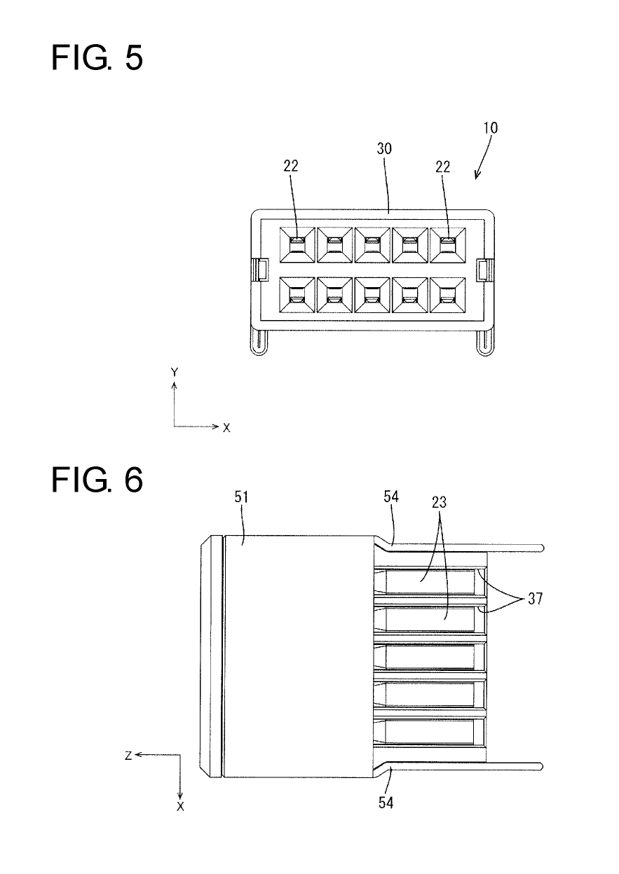

One embodiment of the invention is described with reference to FIGS. 1 to 9. A communication connector 10 of this embodiment is installed in a vehicle, such as an electric or hybrid vehicle and disposed, for example, in a wired communication path between an in-vehicle electrical component (car navigation system, ETC, monitor or the like) in the vehicle and an external device (camera or the like) or between in-vehicle electrical components. In the following description, left and right sides of FIG. 3 are referred to as front and rear sides concerning a front-rear direction (Z axis), upper and lower sides of FIG. 3 are referred to as left and right sides concerning a lateral direction (X axis) and a vertical direction (Y axis) is based on FIG. 5.

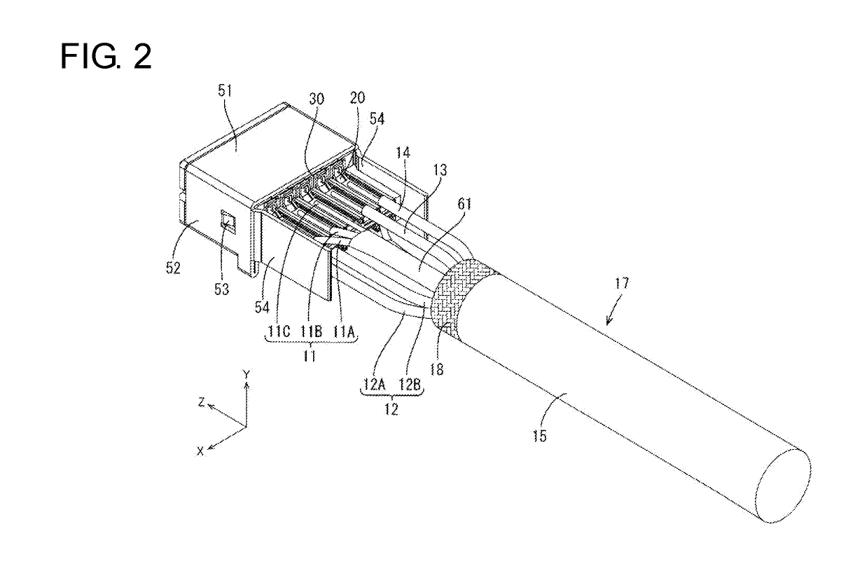

The communication connector 10 of this embodiment includes, as shown in FIG. 2, a shield cable 17, terminals 20 to be connected respectively to wires 11 to 14 of the shield cable 17, a housing 30 for accommodating the terminals 20, and a shield case 50 for covering the housing 30 and the shield cable 17.

### (Shield Cable 17)

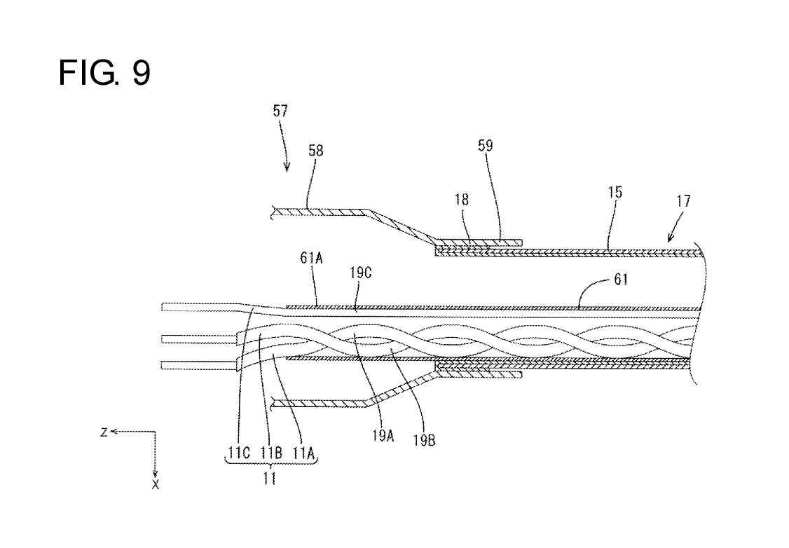

The shield cable 17 is capable of high-speed communication of 1 GHz or faster and includes, as shown in FIGS. 2 and 3, wires 11 to 14 for transmitting communication signals, a shield layer 18 (also see FIG. 9) collectively surrounding the wires 11 to 14 and constituted by a braided wire formed by braiding thin metal wires and an insulation coating 15 (sheath) covering the outer periphery of the shield layer 18 and made of insulating synthetic resin. Further, a filling member (not shown) composed of insulating threads or paper tape is filled between the wires 11 to 14 and the shield layer 18.

The wires 11 are wires of a differential pair cable with a shield and a drain wire. As shown in FIG. 9, the wires 11 include first and second wires 11A, 11B and a drain wire 11C. The wires 11A, 11B are adjacent to each other as shown in FIG. 9 and constitute a twisted pair cable by being twisted with each other. The wires 11 are, for example, wires of USB (Universal Serial Bus) 3.0 standard and two sets of wires 11 are provided.

The wires 12 are for communication having a lower maximum data transfer speed than communication using the wires 11 and constitute a twisted pair cable without shield. As shown in FIG. 2, the wires 12 include first and second wires 12A, 12B of USB 2.0 standard. The wires 12A, 12B are twisted with each other in the part covered with the insulation coating 15.

The wire 13 is a power supply wire connected to an unillustrated power supply, and the wire 14 is a ground wire connected to ground. As just described, the shield cable 17 has ten wires, i.e. two sets of the wires 11 (wires 11A, 11B and drain wires 11C), one set of wires 12 (wires 12A, 12B), the wire 13 and the wire 14.

As shown in FIG. 2, one set of the wires 11, out of two sets of the wires 11, and the wires 13, 14 are aligned laterally in a row and the other set of the wires 11 and the wires 12 are aligned laterally in a row below the former wires. Further, the one set of the wires 11 and the other set of the wires 11 are disposed at positions diagonal to each other. Note that, in FIG. 9, only the wires 11 on an upper side are shown and the other wires are not shown.

End parts of the wires 11 to 14 are exposed and are not covered with the shield layer 18 and the insulation coating 15. This enables the respective wires 11 to 14 to be bent at the end parts independently of each other and easily connected to the respective terminals 20.

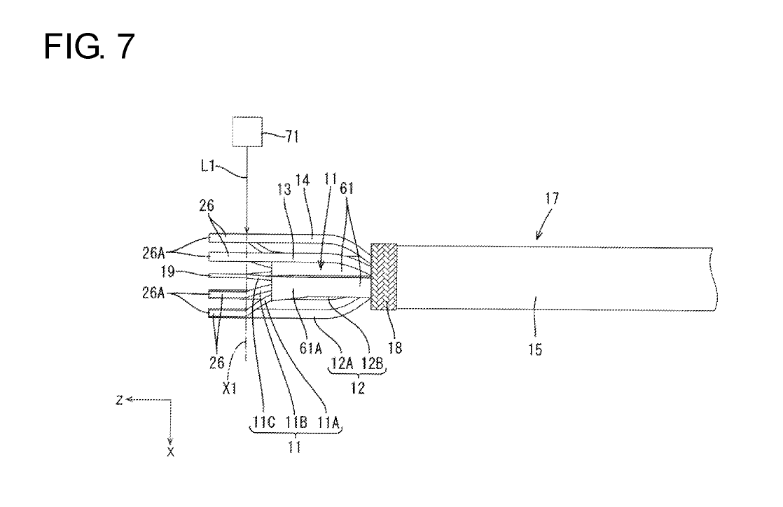

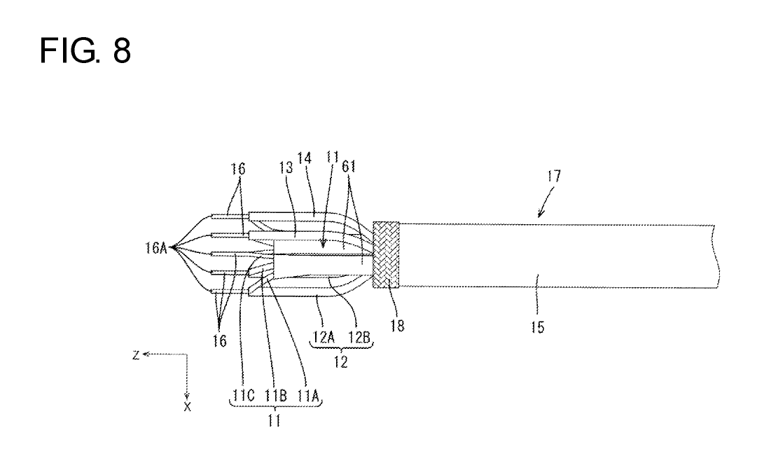

Each wire 11 to 14 excluding the drain wires 11C is configured such that a conductor part made of a metal wire is covered with an insulation layer 26 (see FIG. 7) made of insulating synthetic resin, and the end part (end part on the terminal side) thereof has the insulation layer 26 stripped to expose a conductor part 16 (see FIG. 8) to be connected to the terminal 20. The drain wire 11C is composed only of a conductor part 16 made of a metal wire, but may be composed of a conductor part and an insulation layer.

As shown in FIG. 9, the first wire 11A, the second wire 11B and the drain wire 11C are surrounded by a shield member 61. The shield member 61 is a conductive thin film and a metal tape called Al-Pet (registered trademark) can be, for example, used as such. Al-Pet is formed by laminating an aluminum foil and polyethylene terephthalate via polyvinyl chloride (PVC) or the like and molding the laminate into a tape. The drain wire 11C is disposed in contact with the inner peripheral surface of the shield member 61. In this way, the drain wire 11C and the shield member 61 are electrically connected. The shield member 61 is interposed between the insulation coating 15 and the first and second wires 11A, 11B and the drain wire 11C and surrounds exposed parts 19A, 19B and 19C of the wires 11A, 11B and the drain wire 11C.

### (Terminal 20)

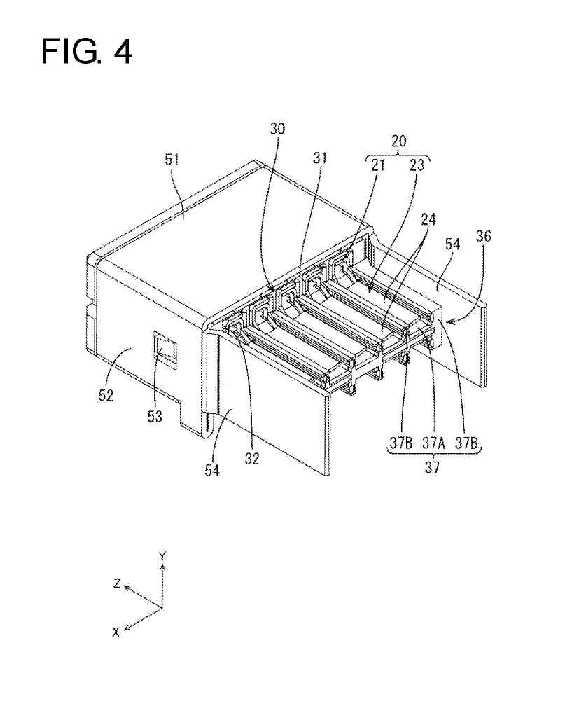

As shown in FIG. 4, a rectangular tubular terminal connecting portion 21 is formed at the front side of the terminal 20. A wire connecting portion 23 is formed integrally behind the terminal connecting portion 21 and is to be connected to the conductor of the wire 11 to 14. The terminal connecting portion 21 is provided with a resilient contact piece 22 (see FIG. 5) to be connected to a male terminal of a mating connector. The wire connecting portion 23 includes a bottom plate 24, and the conductor part of the wire 11 to 14 is connected electrically to the wire connecting portion 23, for example, by being soldered or welded to the bottom plate 24.

### (Housing 30)

The housing 30 is made of insulating synthetic resin and, as shown in FIG. 4, includes a housing body 31 for accommodating the terminal connecting portions 21 of the respective terminals 20 and an extending portion 36 extending behind the housing body 31 and having a smaller thickness. The housing body 31 has a rectangular parallelepiped shape and includes cavities 32 for accommodating the terminals 20. Five cavities 32 arranged in the lateral direction are provided in each of upper and lower stages.

Each cavity 32 has a rectangular cross-section corresponding to the outer peripheral shape of the terminal connecting portion 21 and extends in the front-rear direction according to a length of the terminal connecting portion 21. A front stop wall (not shown) is formed in a front end of the cavity 32 for restricting a forward movement of the terminal 20.

The extending portion 36 extends rearward from the rear end of the housing body 31. As shown in FIGS. 4 and 6, the extending portion 36 includes placing grooves 37 arranged such that the wire connecting portions 23 of the respective terminals 20 can be placed therein. Each placing groove 37 includes a bottom surface 37A and groove walls 37B rising from both side edges of the bottom surface 37A. The placing grooves 37 are formed laterally side by side on each of the upper and lower surfaces of the extending portion 36 according to the number of the terminals 20.

### (Shield Case 50)

As shown in FIG. 1, the shield case 50 includes a first shield case 51 for covering the housing body 31 and a second shield case 57 disposed behind the first shield case 51 for covering the wires 11 to 14. Further, the shield case 50 is connected electrically to ground. The first shield case 51 is, for example, made of metal such as copper or copper alloy and, as shown in FIG. 2, includes a housing surrounding portion 52 in the form of a rectangular tube surrounding the housing 30 and connecting portions 54 to be connected electrically to the second shield case 57.

Resiliently deformable locked portions 53 are provided on left and right side surface parts of the housing surrounding portion 52. When the first shield case 51 is fit to the housing 30 from behind the housing 30, the locked portions 53 are locked to locking portions (not shown) formed by cutting side surfaces of the housing 30. The connecting portions 54 are plate-like parts extending rearward from the rear ends of the side surfaces of the housing surrounding portion 52, and are connected electrically to the second shield case 57 by contacting inner surfaces of the second shield case 57.

The second shield case 57 is made of metal such as copper or copper alloy and includes, as shown in FIG. 1, a box-shaped wire shielding portion 58 open on a front side and a hollow cylindrical shield connecting portion 59 to be fit externally on the shield cable 17. The wire shielding portion 58 surrounds all of the wires 11 to 14. The shield connecting portion 59 is, for example, connected to the shield layer 18 folded outside the insulation coating 15 at an end part of the shield cable 17. The shield connecting portion 59 and the shield layer 18 can be fixed, for example, by welding or crimping.

Next, a method for manufacturing the communication connector 10 is described. First, as shown in FIG. 7, the end parts of the shield layer 18, the insulation coating 15 and the shield members 61 are stripped in the shield cable 17 to expose the end parts of the wires 11 to 14 on the side of the terminals 20. Further, the end part of the shield layer 18 is folded onto the outer peripheral surface of the insulation coating 15. Here, the shield member 61 is stripped over a shorter length than the insulation coating 15. In this way, an end part of the shield member 61 is exposed.

### (Cutting Step)

Subsequently, the shield cable 17 is fixed to an unillustrated placing table and a laser beam L1 is emitted from a laser beam emitting device 71. The laser beam emitting device 71 includes unillustrated laser oscillator and converging lens for converging and emitting a laser beam from the laser oscillator to outside. Note that a carbon dioxide gas laser can be, for example, illustrated as the laser beam emitting device 71, but there is no limitation to this.

Subsequently, the laser beam emitting device 71 is moved along an X-axis direction and the laser beam L1 emitted from the laser beam emitting device 71 is successively irradiated to the insulation layers 26 of the respective wires 11 to 14. At this time, by irradiating the laser beam L1 from upper and lower sides of each wire 11 to 14, each insulation layer 26 is cut over the entire circumference. Note that a cutting line X1 of each insulation layer 16 at this time extends along a direction perpendicular to an extending direction of each wire 11 to 14, for example, as shown by chain double-dashed line of FIG. 7.

### (Removing Step)

Subsequently, an end part 26A (see FIG. 7) of each cut insulation layer 26 is pulled leftward in FIG. 7 using a tool and removed. In this way, an end part 16A of the conductor part 16 of each wire 11 to 14 is exposed as shown in FIG. 8.

### (Connecting Step)

Subsequently, as shown in FIG. 3, the end part 16A of the conductor part 16 of each wire 11 to 14 is connected to the wire connecting portion 23 of each terminal 20 by soldering, welding or the like. Thereafter, the first shield case 51 is mounted on the housing 30, and the second shield case 57 is attached to the first shield case 51. In this way, the communication connector 10 is completed.

In this embodiment, the insulation layers 26 of the wires 11 to 14 are cut using a laser beam. In the case of cutting the insulation layer 26 using a wire stripper or the like, the insulation layer 26 needs to be held by the wire stripper and needs to be exposed by stripping the shield member 61. If the laser beam is used, a situation where the shield member 61 is stripped to hold the insulation layer 26 can be suppressed.

Specifically, in the case of cutting the insulation layer 26 using the wire stripper or the like, it is difficult to completely cut the insulation layer 26 over the entire circumference. Thus, to remove the end part 26A of the insulation layer 26, it is necessary to hold parts of the insulation layer 26 at both sides of the cutting line X (see FIG. 7) and tear a part of the insulation layer 26 by pulling the end part 26A. To this end, an exposed part 61A of the shield member 61 needs to be stripped.

In this embodiment, the insulation layer 26 can be burned over the entire circumference thereof by using the laser beam. Thus, the end part 26A can be removed easily by gripping only the end part 26A with a tool and pulling this end part 26A. Thus, the exposed part 61A need not be stripped and can remain. This can suppress a situation where a part not covered with the shield member 61 is formed in the wire 11 and can suppress a reduction of communication quality.

Further, the shield cable 17 includes the first and second wires 11A, 11B, and the wires 11A, 11B are surrounded by the shield member 61 while constituting the twisted pair cable by being twisted with each other. Since the shield member 61 surrounding the twisted pair cable needs not be stripped in this embodiment, a situation where the twisted pair cable is untwisted can be suppressed.

Further, the communication connector 10 of this embodiment includes the wires 11, 12, 13 and 14 for transmitting communication signals, the terminals 20 to be connected to the respective wires 11, 12, 13 and 14, the housing 30 for accommodating the terminals 20, the insulation coating 15 for collectively covering the wires 11, 12, 13 and 14, the end part of each wire 11, 12, 13, 14 on the terminal side serving as the exposed part not covered with the insulation coating 15, and the conductive shield members 61 for surrounding the wires 11, and the shield member 61 is interposed between the insulation coating 15 and the wires 11A, 11B and configured to surround the exposed parts 19A, 19B and 19C of the wires 11A, 11B and the drain wire 11C.

According to this embodiment, the end part of each wire 11, 12, 13, 14 on the terminal side serves as the exposed part not covered with the insulation coating 15. This enables each wire 11, 12, 13, 14 to be bent easily at the end part and easily connected to each terminal 20. Here, in the wires 11A, 11B and the drain wire 11C, parts covered with the insulation coating 15 and the exposed parts 19A, 19B and 19C are covered with the shield member 61. This can suppress a situation where an impedance changes between the parts covered with the insulation coating 15 and the exposed parts 19A, 19B in the wires 11A, 11B and can suppress a reduction of communication quality.

If the exposed part 61A of the shield member 61 is stripped, the exposed parts 19A, 19B are arranged to directly face the wire shielding portion 58 of the shield case 50. This makes a distance of the exposed parts 19A, 19B to ground longer than distances of the other parts to ground, whereby an impedance changes. In this embodiment, such a situation can be suppressed since the exposed part 61A of the shield member 61 need not be stripped.

Further, the shield member 61 is connected electrically to the drain wire 11C. If this configuration is employed, the influence of noise can be further reduced by electrically connecting the drain wire 11C to ground.

The invention is not limited to the above described and illustrated embodiment. For example, the following embodiments also are included in the scope of the invention.

The material of the shield members 61 is not limited to that illustrated in the above embodiment and can be changed.

The number and arrangement of the wires constituting the shield cable 17 are not limited to those illustrated in the above embodiment and can be changed.

Although the wires 11A, 11B and the drain wire 11C are surrounded collectively by the shield member 61 in the above embodiment, there is no limitation to this. For example, only the wires 11A, 11B may be surrounded by the shield member 61.

Although the wires 11A, 11B of the twisted pair are surrounded by the shield member 61 in the above embodiment, there is no limitation to this. It is sufficient to surround at least one wire by the shield member 61.

The cutting step is illustrated in which a laser beam is irradiated to an insulation layer of a shield cable with a wire configured by coating a conductor part by the insulation layer and a conductive shield member for surrounding the wire, thereby cutting the insulation layer. However, there is no limitation to this. The shield member may be cut, for example, by a cutter or the like.

### List of Reference Signs

10: communication connector

11A, 11B: a pair of wires (at least one of a plurality of wires)

15: insulation coating

16: conductor

16A: end part of conductor

17: shield cable

19A, 19B, 19C: exposed part

20: terminal

26: insulation layer

26A: end part of insulation layer

30: housing

61: shield member

1-2. (canceled)

3. A communication connector, comprising:
wires for transmitting communication signals;
terminals each including a wire connecting portion to be connected to each wire;
a housing including a housing body for accommodating terminals and an extending portion extending rearward from a rear end of the housing body, the extending portion including placing grooves arranged such that the wire connecting portions of the respective terminals can be placed therein;
an insulation coating for collectively covering of wires, an end part of each defining an exposed part not covered with the insulation coating; and
a conductive shield member for surrounding at least one of the plurality of wires;
the shield member being interposed between the insulation coating and the one wire and configured to surround the exposed part of the one wire.
